(19) United States
(12) Patent Application Publication
(10) Pub. No.: US 2004/0090461 A1
(43) Pub. Date: May 13, 2004

(54) Interface devices

(76) Inventor: Guy de Warrenne Bruce Adams, Stroud Gloucestershire (GB)

Correspondence Address: HEWLETT-PACKARD COMPANY, Intellectual Property Administration, P.O. Box 272400, Fort Collins, CO, 80527-2400, US

(21) Appl. No.: 10/697,937

(22) Filed: Oct. 31, 2003

(30) Foreign Application Priority Data
Oct. 31, 2002 (GB) 0225425.8

(51) Int. Cl. G09G 5/00

(52) U.S. Cl. 345/765

(57) ABSTRACT

Apparatus for producing a user interface device, said device having at least one user input region identified by a symbol and, operatively associated with the or each respective input region, at least one respective set of computer instructions for generating command signals for use in controlling a remote target device, said apparatus being arranged to:

a) access at least one said set of computer instructions from a location remote from the interface device;

b) produce an association file associating at least one selected said set of computer instructions with the or each respective said user input region; and

c) generate a symbol identifying a control function relating to the or each respective set of computer instructions.

### FIELD OF INVENTION

The invention relates generally to the production of interface devices for controlling at least one remote device. More particularly, but not exclusively, the invention relates to apparatus and methods for producing, and to a computer program for producing, such interface devices, and to an interface for use in accessing media records stored as records on a remote storage medium.

### BACKGROUND ART

UK Patent Application number 2 369 706 A discloses a communications device including a user interface unit adapted to receive a customization sheet including human sensible symbols for indicating an input location and at least one machine-readable symbol for identifying a parameter associated with the customization sheet. The device may be used for internet shopping or to remotely control a TV.

International Patent Application publication number WO 02/07122 A2 discloses a remote control including ii) blank “hard” keys that may be custom labelled using a precut label or label strip and ii) alternatively, an LCD touch screen. A user may download selected command codes from a database via a website.

### SUMMARY OF THE INVENTION

According to a first aspect of the invention, there is provided apparatus for customising user interface devices, each of the user interface devices having at least one user input region identified by a symbol and, operatively associated with the or each respective input region, at least one respective set of computer instructions for generating command signals for use in controlling at least one respective function of a remote target device, said apparatus being arranged to:

a) receive control function selection information relating to at least one said function for inclusion in the interface device;

b) in accordance with the control function selection information, access from a location remote from the interface device at least one said set of computer instructions corresponding to a selected said at least one function;

c) receive layout selection information relating to a layout of the user interface device;

d) generate at least one symbol for identifying at least one of a control function, disposition and size of the or each respective user input region; and

e) in accordance with the layout selection information, produce an association file associating at least one selected said set of computer instructions with the or each respective said user input region, and initiate printing of the at least one symbol.

In accordance with a further aspect of the invention, there is provided apparatus for producing a user interface device, said device having at least one user input region identified by a symbol and, operatively associated with the or each respective input region, at least one respective set of computer instructions for generating command signals for use in controlling a remote target device, said apparatus being arranged to:

a) access at least one said set of computer instructions from a location remote from the interface device;

b) produce an association file associating at least one selected said set of computer instructions with the or each respective said user input region; and

c) generate a symbol identifying a control function relating to the or each respective set of computer instructions.

In accordance with a still further aspect of the invention, there is provided a computer program, for use in producing a user interface device having at least one user input region identified by a symbol and, associated with the or each respective input region, at least one respective set of computer instructions for use in controlling a remote target device, said computer program comprising computer executable instructions for causing computer apparatus to:

a) create an association file linking at least one selected said set of computer instructions, obtained from a location remote from the interface device, with the or each respective said user input region; and

b) generate a symbol symbolising the or each respective set of computer instructions.

In accordance with a still further aspect of the invention, there is provided an interface device, customised for use in controlling a target device to access records stored on a remote storage medium, the apparatus comprising: a plurality of switches; a plurality of corresponding switch actuating regions; symbols, corresponding to target device control functions, respectively printed over said actuating regions; a controller for controlling the interface; a path arrangement operably connecting the or each switch with said controller; and transceiver apparatus for communication with said target device; whereby a user can use said symbols to identify a desired switch actuating region for generating and transmitting a command signal to the target device for accessing a selected record in desired manner.

In accordance with a yet further aspect of the invention, there is provided a method of producing a user interface device having user input regions arranged for causing respective sets of computer instructions to be processed on the interface device so as to generate respective command signals for controlling a remote device, the method comprising;

a) providing a customisation interface enabling an operator to identify and select desired said sets of computer instructions corresponding to desired control functions for controlling at least one remote device;

b) causing the selected sets of computer instructions to be transmitted to a user interface device for storage thereon;

c) receiving information relating to a disposition of the user input regions on the user interface device; and

d) printing onto a surface of the user interface device, in alignment with respective said user input regions of the user interface device, symbols respectively corresponding to the selected sets of computer instructions.

### BRIEF DESCRIPTION OF THE DRAWINGS

In order that the invention may be well understood, various embodiments thereof will now be described, by way of example only, with reference to the accompanying drawings, in which:

FIG. 1 is a schematic view from one side of an interface device;

FIG. 2 is a partial cross-section of the device of FIG. 1;

FIG. 3 is a schematic view of a CD for which the interface device is customised;

FIG. 4 is a schematic drawing illustrating apparatus for producing the interface device;

FIG. 5 is a flow diagram illustrating a method for producing the interface device using the apparatus shown in FIG. 4; and

FIG. 6 is an exploded view of a printed overlay and an interface device blank having alignment symbols for aligning the overlay.

### DETAILED DESCRIPTION OF THE DRAWINGS

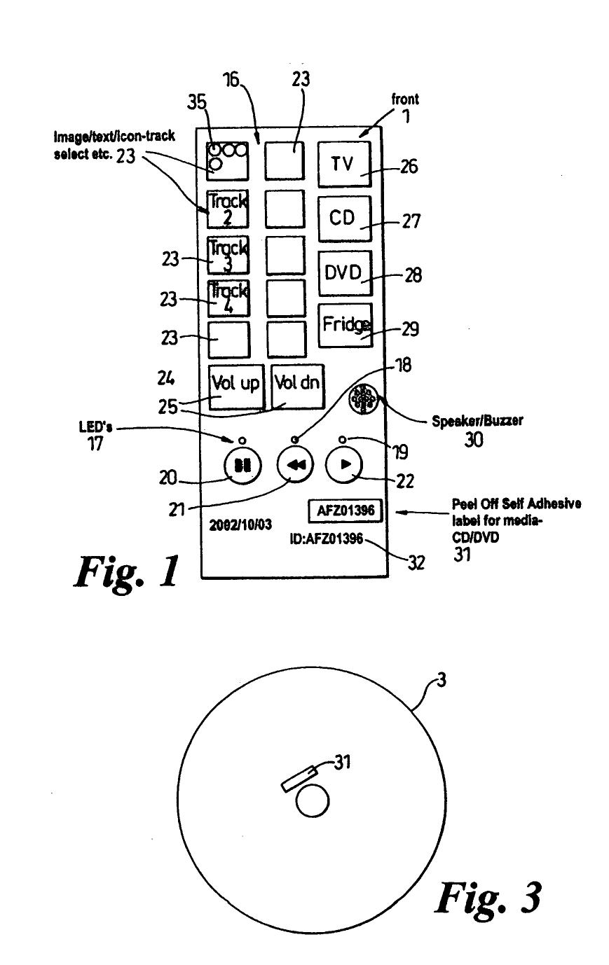

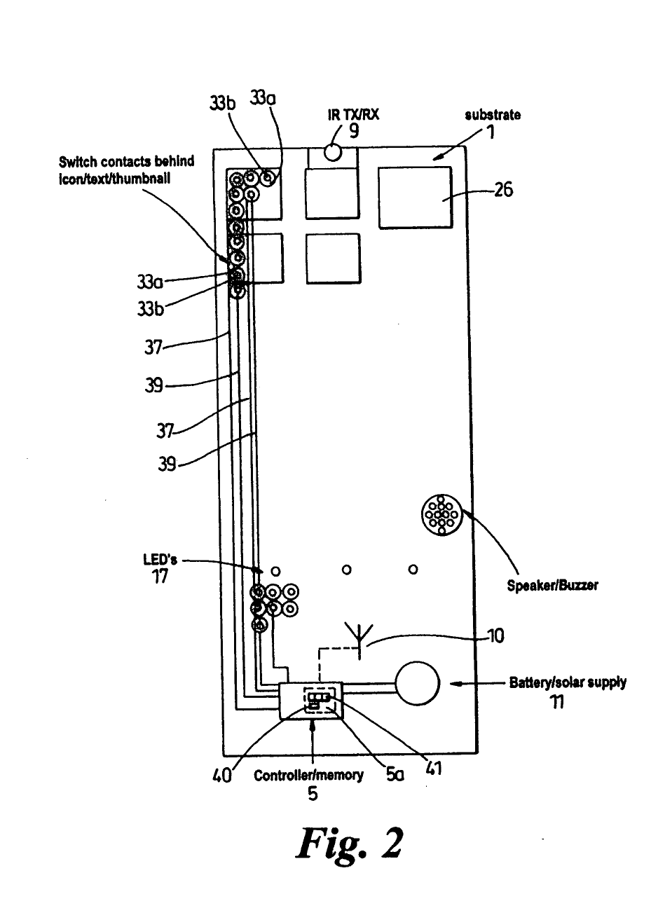

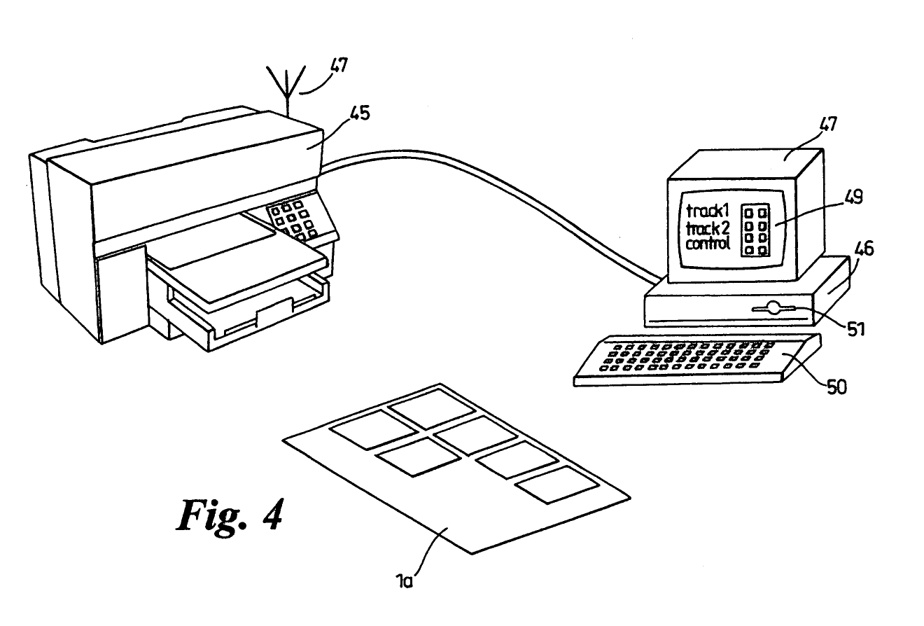

FIGS. 1 and 2 show a user interface device 1 customised for use in remotely accessing records in the form of audio recordings stored on a storage medium in the form of a known compact disc (CD) optical storage device 3 (FIG. 3). The CD 3 is readable in a known manner on a user access device in the form of a CD player. Alternatively or additionally, the records could be, for example, photographic or video images, audio or audiovisual clips, or other rich media records. Alternatively or additionally, the storage medium could be, for example, another form of optical storage device, a digital audio tape device, a solid state memory device, or any other suitable storage medium. As best seen in FIG. 2, the interface device 1 has a controller 5 in the form of an integrated circuit for controlling the interface device 1. The controller integrated circuit also includes non-volatile memory 5a. A power source 11 in the form of a battery, or other power source such as a solar cell, is connected for providing power to the interface device 1. A wireless module in the form of an infra-red (IR) transceiver 9 is connected to the controller 5, for communicating with the CD player or other remote user access device. For example, the access device with which the transceiver 9 is capable of communicating could, for example be a printer, personal computer or personal digital assistant, a display device such as a television, a refrigerator, radio tuning device, gramophone player, or any other controllable electronic device.

A further, optional, wireless module, in the form of a radio frequency (RF) transceiver 10 is connected to the controller 5 for communicating with apparatus for producing the interface device 1, as described in further detail below. The term wireless means any form of connection without wires, and includes radio frequency (RF) and infra-red communication technologies.

An identification number, indicated by reference sign 32, is permanently marked on the front face of the interface device 1. A self-adhesive label 31 bearing the same identification number is also initially provided on the interface device 1. The label 31 is arranged for easy removal from the interface device 1 for application to the CD 3 as shown in FIG. 3, or to any other storage medium to which the interface device 1 is customised. Thus, the interface device 1 can be easily matched with the CD 3 using the identification number.

As best seen in FIG. 1, the interface device 1 comprises a surface portion 16. The surface portion 16 is formed by a face of the body of the interface device 1, but may alternatively be provided by a printed sheet subsequently attached to the body. The surface portion 16 carries printed symbols 20 to 29. Symbols 23 correspond to the respective audio recordings. These symbols 23 may all be of the same size and type. In an alternative embodiment, the symbols 23 may vary in size and/or type, for example in accordance with the type of record represented. The symbols 23 could, for example be descriptive text or iconic images associated with a record, filenames, or any other convenient descriptor. The symbols 23 are usable in the manner of an index card, for user identification and selection of audio recordings on the CD 3.

Symbols 24 and 25 correspond to volume up and volume down controls. Symbols 26 to 29 correspond to respective remote devices to which the command signals generated by the interface device 1 may be transmitted by the interface device 1. For example, the symbols 26 to 30 relate to a television or other display device, CD player, DVD player, set top box connected to a display device, and refrigerator respectively. Many additional or alternative types of remote device may be controlled by the interface device 1. Symbols 20, 21, 22 correspond respectively to pause, move back and start/play commands. Many suitable additional or alternative commands will be apparent to the skilled reader. For example where the interface device is customised for use with a CD storage medium carrying still images for display on a CD DVD player target device, symbols may be provided corresponding to zoom, rotate, slide show mode, edit red-eye, further edit functions, and any further desired functions.

Light emitting diodes (LEDs) 17, 18, 19 are provided that are arranged to light up when the control symbols 20 to 22 are used in generating command signals for controlling functions of a remote device. The LEDs 17, 18, 19, or further LEDs (not shown), may also be arranged to light up when other symbols 23 to 29 are used. A loudspeaker 30 is also provided. One function of the LEDs 17 to 19 and the loudspeaker 30 is to provide visual and audible feedback to a user during actuation of the interface device 1, to confirm correct actuation and thus facilitate accurate user control of the device 1. The loudspeaker 30 can also be employed, for example, for playing audio clips to facilitate selection of a stored recording.

As shown in FIG. 2, an array of switches is provided beneath the surface portion 21 on which the symbols 20 to 29 are printed. The switches in FIG. 1 are formed by conductive contacts 33a, 33b on respective opposed inner surfaces formed by laminations of the interface device 1. The laminations are arranged such that the contacts 33a, 33b are resiliently biased towards a “switch open” position in which the contacts 33a, 33b do not interengage. A switch is closed by applying pressure to an actuating region, or user input region 35 of the surface portion 21 to overcome the bias and press the contacts 33a, 33b of the switch together to actuate the switch. The size and shape of a user input region 35 can vary depending on the size and design characteristics of the switch 33a, 33b. In the interface device 1 of FIGS. 1 and 2, the size of each user input region 35 is coterminous with an outer peripheral extent of its corresponding switch 33a, 33b. In order to simplify the drawings, not all of the switches 33a, 33b are shown.

Each switch 33a, 33b is operably connected to the controller 5 by respective paths 37, 39 in the form of electrically conductive tracks formed by conductive wires embedded in the body of the interface device. Paths 37 form a common connection with the contacts 33a. Each of the paths 39 is connected to one respective contact 33b. When a pair of contacts 33a and 33b is brought together, the path 39 is thus grounded, and the switch 33a, 33b is thus activated. In order to simplify the drawings, not all of the paths 37, 39 are shown. Many alternative ways of arranging the paths 37, 39 will be apparent to the skilled reader. For example, in one alternative arrangement a grid of paths aligned with mutually perpendicular (X-Y) axes is formed. The X and Y paths are arranged on spaced, oppositely and inwardly facing surfaces of respective laminations. Regions of an outer surface of one of the laminations may be pressed by a user so as to bring horizontal and vertical paths into contact where they cross in the grid. A sequencer is provided to scan the grid to sense locations of crossed paths (switches) in the grid that have been activated.

Whilst the paths 37, 39 comprise embedded wires, many alternative ways of forming the paths will be readily apparent to the skilled reader. For example, the paths 37, 39 may be formed by any of the following processes: embossing by transferring preprepared tracks from a carrier to the interface device 1 under pressure; transferring preprepared tracks from a carrier and adhering the tracks to the interface device; direct printing of conductive material onto the interface device so as to form tracks, using a printer adapted for this purpose; or any other convenient method. Optical waveguides could alternatively be used instead of the conductive tracks to transmit signals from the switches 33a, 33b to the controller 5, or any suitable further alternative means of transmission.

A mapping 40 in the form of a look-up table, or file containing associations, is stored in the memory 5a, or in any other suitable non-volatile memory on the interface device 1 that is accessible to the controller 5. The mapping 40 provides a logical association between the switches 33a, 33b and respective storage locations in the memory 5a containing respective sets 41 of computer instructions. The symbols 20 to 29 are aligned with user input regions 35 of the switches 33a, 33b such that pressing in one of the user input regions 35 indicated by a selected symbol 20 to 29 causes the controller 5, using the mapping 40, to access and execute a set 41 computer instructions adapted to generate command signals associated with the selected symbol 20 to 29.

Record symbols 23 are thus associated, by virtue of the associations contained in the mapping and the symbols' disposition relative to the switches 33a, 33b, with computer instruction sets 41 for causing the CD player or other access device to select and play respective audio recordings or other records indicated by the record symbols 23. Control function symbols 20 to 22, 24, 25 are associated in a similar manner with instruction sets 41 for controlling the corresponding functions of the CD player and other controllable devices. Multiple instruction sets 41 may be provided capable of association with one control function symbol. An appropriate set 41 is dynamically associated with the symbol according to the target device presently selected.

Target symbols 26 to 29 are associated, also in the manner described above, with instruction sets 41 that cause the interface device 1 to ensure that command signals generated by the interface device 1 function correctly with the target device selected to be controlled. For example, as noted above, different command signals might be generated by pressing the volume up symbol 24, depending on which target symbol 26 to 29 is presently actuated.

Each symbol 20 to 29 is aligned with a respective plurality, or group, of user input regions 35 corresponding to a plurality of respective switches 33a, 33b. Providing a grid of many smaller switches 33a, 33b allows the user more flexibility in selecting the size and disposition of the symbols 23 to 30 when producing a customised interface device 1. However, in an alternative embodiment (not shown), the switches 33a, 33b are larger than in the embodiment of FIG. 2 and one switch 33a, 33b, and one user input region 35, is aligned under each symbol 20 to 29. It will be understood that any other convenient size of user input region could alternatively be provided. Also, the peripheral extent of the user input regions 35 need not be coterminous with the peripheral extent of the switches 33a, 33b. For example, the user input regions 35 could extend radially outwardly of the outermost periphery of the switches 33a, 33b.

Alternative suitable forms of switch will be readily apparent to the skilled man. For example, pressure or touch sensing elements could be incorporated within the interface device 1 instead of the contacts 33a, 33b. The interface device may be provided with a specially adapted surface portion 21 if necessary for facilitating pressure or touch sensing. For example, capacitive touch sensing may require an electrically conductive surface. In another alternative form, the switches are printed inductive coils and require a specially adapted wand for actuation.

To use the interface device 1, a user views the printed index of record symbols 23 to review the contents of the CD 3 to for which the interface device 1 is adapted. The user selects a desired audio recording by pressing on a record symbol 23 corresponding to the desired recording. The record symbol 23 is disposed in alignment with several switch user input regions 35, so that the pressing action causes activation of at least one corresponding switch 33a, 33b. The or each switch generates a signal to the controller 5. The controller 5 uses the mapping 40 to identify a location in the memory Sa where there is stored a computer instruction set 41 corresponding to the selected audio recording. The controller 5 executes the identified computer instruction set 41 so as to generate a command signal for causing the CD player to select and play the selected audio recording. The controller then causes the transceiver 9 to transmit the generated command signal to the CD player. This provides a convenient and efficient method for a user to select and play audio recordings on a selected storage medium, without having to cross reference a separate index of contents, such as is generally provided on a CD case, for example, and control buttons one or more control devices. Indeed, present processes, say for playing a video track on a DVD medium through a TV, are sometimes still more complex: in addition to referencing the DVD index the user has to navigate through at least one menu screen, and is often required to use separate controls for the TV and DVD devices to carry out a desired range of control functions.

The user may alternatively wish to use the interface device to operate a remote device other than the CD player. In this case, the user presses a target symbol such as TV 26. The target symbol 26 is disposed in alignment with several user input regions 35, so that the pressing action causes activation of at least one corresponding switch 33a, 33b. The switch generates a signal to the controller 5. The controller uses the mapping 40 to identify a location in the memory 5a where there is stored a computer instruction set 41 corresponding to the selected target symbol 26.

The controller 5 then automatically processes the identified computer instruction set 41. The identified computer instruction set 41 includes a script in the form of a sequence of instructions that is interpreted by the controller 5. The script causes the interface device to use only those associations in the mapping 40 that relate to computer instruction sets 41 adapted to generate command signals that work with the TV, temporarily amending the mapping 40 if necessary. For example, when the play 22 or volume up 24 symbols are pressed, if the TV target symbols is actuated the mapping 40 associates the play 22 and volume up 24 symbols with computer instruction sets 41 for generating change channel and volume up command signals adapted to work with the selected TV. The script also causes the controller 5 to initiate wireless communication between the interface device 1 and a TV associated with the target symbol 26, including sending a command signal to turn on the TV. Many other possible combinations of targets and predetermined controller responses will be apparent to the skilled reader. It will further be apparent that the embodiments of the interface device 1 described above enable a range of particularly convenient use models to be offered.

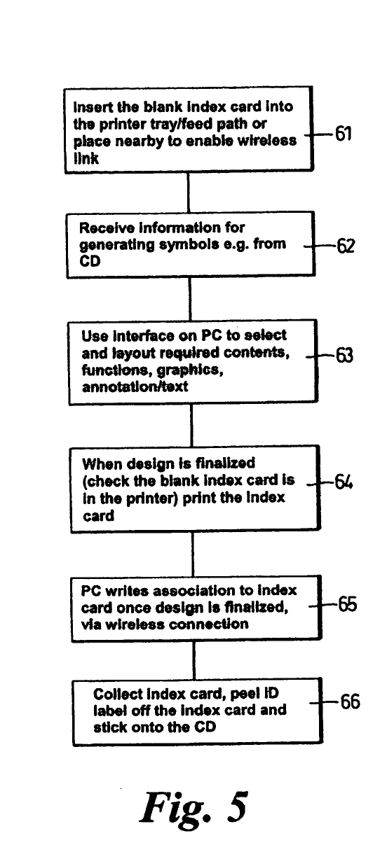

A method and apparatus for producing the user interface device 1 will now be described with reference to FIGS. 4 and 5. A printer apparatus 45 is equipped with ink jet printing technology and an optional transceiver 47 for wireless RF communication. The printer apparatus 45 includes a printing mechanism (not shown) that can accommodate a blank interface device 1a. The interface blank 1a is has the features of the interface device 1 described with reference to FIGS. 1 and 2, with the exception of the printed symbols 20 to 29, the computer instruction sets 41 and the mapping 40. The blank has a body is substantially rigid. Alternatively, the body could be flexible and have a substantially sheet-like form to facilitate passage through a commonly available printing mechanism. The printable surface portion 21 of the blank 1a, including the user input regions 35, is capable of being printed on using known printing technology, for example ink jet or any other suitable printing technology.

The printer mechanism may be a standard printer mechanism of commonly available type, suitable for accommodating the blank 1a. Alternatively, a specially adapted printing mechanism can be provided if required for accommodating a desired type of blank.

A personal computer (PC) 46 is provided that includes an electronic processor (not shown) and non-volatile memory (not shown). The PC is connected to a display device 47 and is programmed to generate, and display on the display device 47, a customisation interface 49 for enabling a user to produce a customised interface device 1 having a desired selection and arrangement of control functions and corresponding printed symbols 20 to 29. The customisation interface 49 is generated by software stored in the non-volatile memory of the PC 46. A user input device in the form of a keyboard 50 is provided for operating the customisation interface 49.

FIG. 5 illustrates a method of producing the customised interface device 1. A blank interface device la is placed close enough to the printer apparatus 45 to enable wireless communication, using the RF transceivers 10 and 47, between the blank 1a and the printer apparatus 45, for example in a feed tray 52 of the printer apparatus 45 (step 61). Alternatively, the optional RF transceivers 10 and 47 may be omitted, and the printer apparatus 45 may be provided with or connected to an IR transceiver that is alignable with the IR transceiver 9 of the interface device blank 1a, for example when the blank 1a is positioned in the printer apparatus' feed tray.

The customisation interface 49 asks the operator to input details of the contents of the CD to the PC (step 62), for use in generating the symbols 23. For example, the CD is placed in a CD drive 51 of the PC, and information relating to the locations of tracks (audio recordings) on the CD 3, track titles, and/or additional information, for example information provided by the CD producer for generating record symbols 23, is uploaded to the PC using the customisation interface 49.

The additional information comprises, for example, specially created images corresponding to each track. Alternatively, the interface device blank la could be provided by a CD provider with such track and/or additional information already stored thereon, which information can be wirelessly communicated to the PC for customisation, for example symbol selection and arrangement, by the operator. Additionally or alternatively, details of a website address are prestored on the blank 1a, for enabling the PC to upload additional information from the website using, for example, an internet connection. Additionally or alternatively, the operator is enabled to create symbols using text or graphics. The customisation interface 49 allows the operator to select and arrange the symbols 23 on the display 47 for printing onto the blank device 1a, and delete symbols relating to tracks that are not required to be printed (step 63).

The customisation interface 49 also accesses sets 41 of computer instructions that are stored in non-volatile memory on the PC 46. These instruction sets 41 are for generating command signals relating, for example, to the control functions and target devices corresponding to the symbols 20 to 22, 24, 25 and 26 to 29 described above. The available instructions sets 41 are presented to the operator in menu form by the customisation interface 49. The sets 41 are presented as text and/or symbols. Additional information for enabling the PC to generate symbols 20 to 22, 24, 25 and 26 to 29 is stored in association with the corresponding instruction set 41. The customisation interface 49 enables selection of desired records and control functions, and provides a representation of the selected arrangement. For example, the user may select the size and/or colour of symbols, add notes or comments to a symbol or group of symbols, add audio clip commentary or delete audio content, and make use of graphics tools provided by the customisation interface 49.

The customisation interface 49 provides a menu enabling the user to select from a selection of target devices prestored on the PC 46, and/or to enable the user to input details of target devices not prestored on the PC 46. For example, the customisation interface 49 may display a menu of target devices, by make and model. Selection of a target device using the menu causes the customisation interface 49 to generate a target device symbol 26 to 30 using the additional information stored on the PC 46 with the appropriate instruction set 41.

Desired control functions can also be selected using a menu provided by the customisation interface 49. Selection of a control function causes the customisation interface 49 to generate a control symbol 20 to 22, 24, 25 using the additional information stored on the PC 46 with the appropriate instruction set 41.

Before printing the symbols 20 to 29 onto the blank 1a, the PC automatically ensures that, when printed on the blank 1a, each symbol will be in alignment with at least one switch user input region 35. This process is carried out during the arrangement process, so that the customisation interface 49 can inform the user when a desired arrangement is not practicable.

Information about the disposition of the switch user input regions 35 on the blank 1a is necessary to arrange the symbols 23 to 25 relative to the user input regions 35. For a commonly used standard blank 1a, this information is prestored in the non-volatile memory of the PC 46. Alternatively, the information is stored in memory on the interface device blank 1a and wirelessly communicated to the PC 46 using the transceivers 10 and 47.

The PC 46 creates the mapping 40, in the form of a file containing logical associations linking a storage location of each computer instruction set 41 on the interface device 1 with a user input region or regions 35 to be overprinted by the symbol 20 to 29 corresponding to that instruction set 41. A plurality of computer sets 41 may be stored on the interface device 1 corresponding to a single control function symbol 20 to 22, 24, 25. The mapping 40 provides dynamic association of a single appropriate instruction set 41 with the symbol according to which target device is selected. Clearly, it may be necessary to use several association tables in the mapping 40 for this purpose.

In a modified method, at least some of the symbols 20 to 29 are preprinted on the interface device blank 1a, and/or at least some sets of computer instructions 41 are in a mapping 40 prestored on the blank 1a.

The operator finally confirms, using the customisation interface 49, that a selected arrangement of symbols 20 to 29 should be printed to form the customised interface device 1. The PC 46 causes the printer apparatus 45 to print the symbols 20 to 29 on the interface device blank 1a in alignment with the user input regions 35 in accordance with the arrangement (step 64). Also, the PC causes the printer apparatus 45, using the transceiver 47 and wireless module 10, to transmit the mapping 40 to the blank 1a, for storage thereon (step 65). The self-adhesive label 31 is transferred from the face of the interface device blank 1a to a location on the CD 3 (step 66).

In a modified apparatus, the printer apparatus 45 includes computer apparatus programmed for putting the customisation interface into effect, together with a display screen and operator input means. In this case, no separate PC, monitor or keyboard is required.

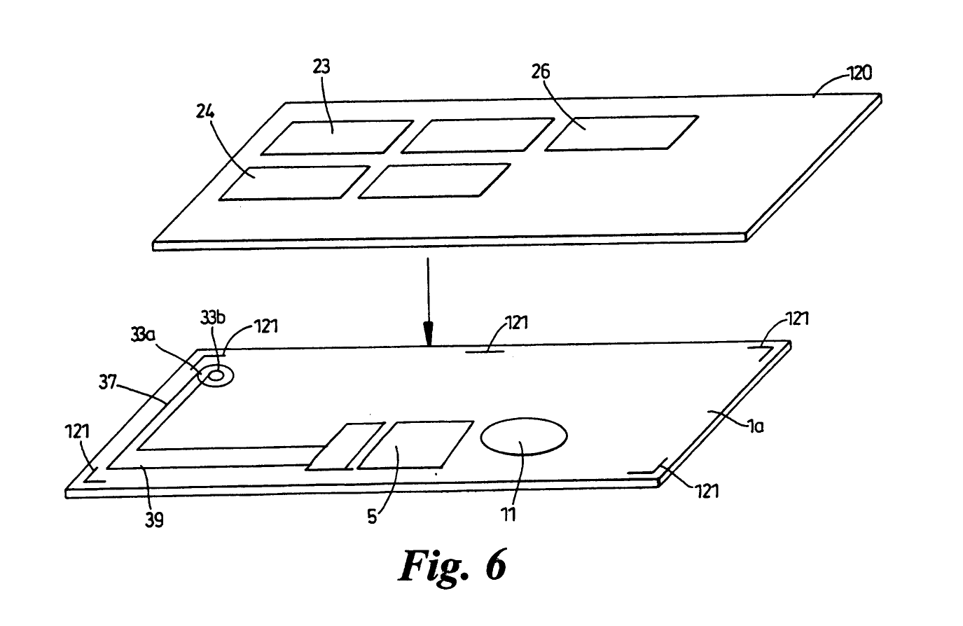

FIGS. 11 and 12 illustrate a further modified method of producing a customised interface device 1. Like reference signs will used to designate features already described above with reference to FIGS. 6 to 8. To avoid unnecessary repetition such features are not described again in detail.

In a modification of the method described above, a separate overlay sheet 120 of printable material, shown in FIG. 6, is fed instead of the blank 1a into the printer apparatus 45 and printed with the arrangement of symbols 20 to 29. The blank 1a is provided with alignment markings 121 for correctly aligning the printed overlay 120 and the blank 1a such that the symbols assume a predetermined disposition relative to the user input regions 35 of the blank 1a. In this manner, the blank 1a does not have to pass through a printer mechanism, and need not be provided with the printable surface portion 21.

The interface device blank 1a can be constructed in many convenient forms, which will be readily apparent to the skilled reader. For example, the blank 1a shown in FIG. 6 for use with the overlay 120 takes the form of a printed circuit board (PCB) having a body of reinforced or unreinforced resin, paths 37, 39 in the form of copper tracks, a controller 5 and module 9 comprising integrated circuits fabricated in a generally known manner, and switches 33a, 33b that are etched. The switches 33a, 33b are alternatively provided in a separate operation by attaching pairs of preformed electrically conductive contacts 33a, 33b to the PCB.

To form a directly printable blank 1a, a PCB similar to that shown in FIG. 6 is provided, except that only one contact 33a of each switch 33a, 33b is attached to the PCB. A layer of printable material (not shown) is then laid over the PCB. The printable layer has contacts 33b on its inwardly directed face that are aligned with the contacts 33a of the PCB, such that the aligned pairs of contacts 33a, 33b form switches.

In a still further alternative, the material of the body of the blank 1a is directly printable, such that the symbols 20 to 29 can be printed directly onto the blank 1a by passing the blank 1a through a printer mechanism. Still further, the paths 37, 39 and circuits for providing various elements of the interface device 1, for example for providing the switches 33a, 33b, controller 5, module 9, battery 11, may be applied to the body of the blank 1a by directly printing conductive material onto the body. Particularly where flexibility is required, blanks 1a can be fabricated for example using a synthetic material such as polyamide or other plastics material, or using paper. Suitable further alternative body materials will be apparent to the skilled reader.

It will be apparent from the above description that the embodiments enable an operator to input a desired layout (appearance/disposition/size) of printed control symbols and that circuit connections in a printed interface device can be dynamically adapted accordingly. A plurality of smaller user input regions are allowed to form one larger input region (user input key) where appropriate. Also, it is possible to dynamically select and configure an interface device and print it locally, providing a quick and convenient service. Relatively cheap interface devices can be provided in this manner, using mass produced blanks for dynamically receiving the printed symbols, connection arrangement and/or program instructions for generating the desired target device operating command signals. Such blanks may be printable using known printing apparatus.

1. Apparatus for customising user interface devices, each of the user interface devices having at least one user input region identified by a symbol and, operatively associated with the or each respective input region, at least one respective set of computer instructions for generating command signals for use in controlling at least one respective function of a remote target device, said apparatus being arranged to:
a) receive control function selection information relating to at least one said function for inclusion in the interface device;
b) in accordance with the control function selection information, access from a location remote from the interface device at least one said set of computer instructions corresponding to a selected said at least one function;
c) receive layout selection information relating to a layout of the user interface device;
d) generate at least one symbol for identifying at least one of a control function, disposition and size of the or each respective user input region; and
e) in accordance with the layout selection information, produce an association file associating at least one selected said set of computer instructions with the or each respective said user input region, and initiate printing of the at least one symbol.

2. Apparatus as claimed in claim 1, wherein the at least one said function is selected from the following operating functions: play, move forward, move back, stop, pause, volume, on/off, change channel, select specific track or other record on a specific storage medium, zoom, rotate, slide show mode, edit red-eye, and further edit image functions.

3. Apparatus as claimed in claim 1, wherein the at least one function includes at least one of: selecting a said target device and initiating communication with a said target device.

4. Apparatus as claimed in claim 1, comprising a customisation interface arranged to display the at least one symbol in the selected layout for printing onto the interface device.

5. Apparatus as claimed in claim 1, comprising a customisation interface enabling an operator to perform at least one of the following operations: identify a said function corresponding to at least one said set of computer instructions; select at least one said set of computer instructions for inclusion on the interface device; select a configuration of the or each symbol; control an arrangement the or each symbol in a desired relative disposition.

6. Apparatus as claimed in claim 1, arranged to cause the association file and the or each selected set of computer instructions to be transmitted for storage on said interface device.

7. Apparatus as claimed in claim 1, wherein at least one said user input region in the selected layout corresponds to a plurality of user input sub-regions.

8. Apparatus as claimed in claim 1, including printer apparatus operable to print the or each symbol directly onto a said interface device.

9. Apparatus as claimed in clam 1, including at least one of the remote set or sets of computer instructions stored thereon.

10. Apparatus as claimed in claim 9, wherein the or each remote set of computer instructions stored on said apparatus is accompanied by information for generating a respective predetermined symbol relating to an associated control function.

11. Apparatus as claimed in claim 9, wherein at least one said set of computer instructions is for generating command signals for causing a remote device to access remotely stored information that a producer of the interface device wishes a user of the interface device to access.

12. A method of producing an interface device, comprising using an apparatus as claimed any one of the preceding claims to print said symbols onto an interface device blank, or onto a surface for subsequent alignment with an interface device blank.

13. A method of producing a customised interface device for use with a predetermined storage medium having predetermined contents stored thereon in the form of records, the method comprising inputting to an apparatus as claimed in claim 1 at least one set of computer instructions for generating a command signal for selecting a respective one of said records, the or each set of computer instructions respectively including information for enabling said apparatus to generate a predetermined symbol relating to a respective said record, for printing said symbol onto the customised interface.

14. A computer program, for use in producing a user interface device having at least one user input region identified by a symbol and, associated with the at least one respective input region, at least one set of computer instructions for use in controlling a remote target device, said computer program comprising computer executable instructions for causing computer apparatus to:
a) create an association file linking at least one selected said set of computer instructions, obtained from a location remote from the interface device, with at least one said user input region;
b) generate a symbol symbolising the or each respective set of computer instructions; and
c) generate a customisation interface arranged to display the or each symbol in an arrangement for printing onto the interface device, wherein the or each symbol is disposed so as to correspond with at least one said user input region.

15. A computer program as claimed in claim 14, wherein the or each set of computer instructions is adapted to generate command signals for controlling at least one respective operating function of at least one controllable device, said operating function being selected from the following: play, move forward, move back, stop, pause, volume, on/off, change channel, select specific track or other record on a specific storage medium, zoom, rotate, slide show mode, edit red-eye, and further edit image functions.

16. A computer program as claimed in claim 14, wherein the or each set of computer instructions is adapted to generate command signals for selecting a said target device and/or initiating communication with a said target device.

17. A computer program as claimed in claim 14, wherein at least one said symbol is disposed so as to correspond with a plurality of mutually adjacent said user input regions, so as to indicate a larger user input region comprising said plurality.

18. A computer program as claimed in claim 14, wherein said computer executable instructions are adapted for causing computer apparatus to generate a customisation interface enabling an operator to perform at least one of the following operations: identify a control function corresponding to at least one said set of computer instructions; select at least one said set of computer instructions for inclusion on the interface device; select a configuration of the or each symbol; control an arrangement the or each symbol in a desired relative disposition.

19. A computer program as claimed in claim 14, wherein said computer executable instructions are adapted for causing computer apparatus to cause transmission of the association file and the or each selected set of computer instructions for storage on said interface device.

20. A computer program as claimed in claim 14, wherein said computer executable instructions are adapted for causing computer apparatus to initiate printing of the or each symbol in a predetermined arrangement, for marking said user input regions.

21. A carrier having thereon a computer program as claimed in claim 14.

22. Computer apparatus loaded with a computer program as claimed in claim 14.

23. Computer apparatus as claimed in claim 22, comprising printer apparatus or a personal computer.

24. An interface device, customised for use in controlling a selected target device to access records stored on a remote storage medium, the apparatus comprising: a plurality of switches; a plurality of corresponding switch actuating regions; permanent symbols, corresponding to target device control functions, respectively printed relative to said actuating regions; a controller for controlling the interface; a path arrangement operably connecting the or each switch with said controller; and transceiver apparatus for communication with said target device, whereby a user can use said symbols to identify a desired switch actuating region for generating and transmitting a command signal to the target device for accessing a selected record in desired manner, the arrangement of the symbols having been selected and printed in accordance with the user's wishes.

25. An interface device as claimed in claim 24, wherein said storage medium comprises an optical storage device, said target device comprises an optical storage device reader, at least some of said control functions relate to selection of respective records in the form of audio tracks stored on said optical storage device, and at least some of the symbols are text or graphical representations of the content of respective said audio tracks.

26. A method of producing an interface device using an apparatus as claimed in claim 1, the method comprising feeding into printer apparatus a blank interface device having a printable surface portion formed integrally therewith, so as to print said symbols in a predetermined arrangement onto said surface portion.

27. A method as claimed in claim 26, wherein the blank interface device is constructed from flexible and substantially sheet-like material, for ease of processing through a printer mechanism.

28. A method of producing an interface device using an apparatus as claimed in claim 1, the method comprising feeding into printer apparatus an overlay sheet having a printable surface portion, so as to print said symbols in a predetermined arrangement onto said surface portion.

29. A method as claimed in claim 28, further comprising aligning the overlay in predetermined positional relationship with a blank interface device.

30. An overlay made using a method as claimed in claim 28.

31. A method of customising user interface devices, each of the user interface devices having at least one user input region identified by a symbol and, operatively associated with the or each respective input region, at least one respective set of computer instructions for generating command signals for use in controlling at least one respective function of a remote target device, the method comprising:
a) receiving control function selection information relating to at least one said function for inclusion in the interface device;
b) in accordance with the control function selection information, accessing from a location remote from the interface device at least one said set of computer instructions corresponding to a selected said at least one function;
c) receiving layout selection information relating to a layout of the user interface device;
d) generating at least one symbol for identifying at least one of a control function, disposition and size of the or each respective user input region; and
e) in accordance with the layout selection information, producing an association file associating at least one selected said set of computer instructions with the or each respective said user input region, and initiating printing of the at least one symbol.

32. A method of customising a user interface device having user input regions arranged for causing respective sets of computer instructions to be processed on the interface device so as to generate respective command signals for controlling a remote device, the method comprising;
a) enabling an operator to identify and select desired said sets of computer instructions corresponding to desired control functions for controlling at least one remote device;
b) causing the selected sets of computer instructions to be transmitted to a user interface device for storage thereon;
c) receiving information relating to a disposition of the user input regions on the user interface device; and
d) printing onto a surface of the user interface device, in alignment with respective ones of said user input regions of the user interface device, symbols respectively corresponding to the selected sets of computer instructions.

33. A method as claimed in claim 32, wherein the relative dispositions and sizes of the symbols is dynamically selectable, at least one of the user input regions being dynamically arranged from a plurality of smaller user input regions.
